(19) United States
(12) Patent Application Publication
(10) Pub. No.: US 2017/0189264 A1
(43) Pub. Date: Jul. 6, 2017

(54) Vibrating double pleasure or double penetration sex toy

(71) Applicant: Kevin Ross, Nebraska City, NE (US)

(72) Inventor: Kevin Ross, Nebraska City, NE (US)

(21) Appl. No.: 15/257,856

(22) Filed: Sep. 6, 2016

Related U.S. Application Data
(60) Provisional application No. 62/214,295, filed on Sep. 4, 2015.

(51) Int. Cl. A61H 19/00; A61H 23/02

(52) U.S. Cl. CPC A61H 19/44; A61H 19/30; A61H 19/34; A61H 23/02; A61H 2201/1628; A61H 2205/087

(57) ABSTRACT

A vibrating double pleasure or double penetration sex toy provides a large protrusion and a vibrating small protrusion at each end of the main body. The sex toy is curved and generally semi-rigid, and the small protrusion is retractable, and extends and retracts when a retraction control button on the bottom surface of the main body is pressed. The small protrusion also provides three vibration speeds, which may be controlled by pressing one of three speed control buttons on the side surface of the main body. The large protrusion and the small protrusion are generally phallic in shape, and may provide removable, flexible covers of various shapes to provide stimulation to different areas.

### CROSS-REFERENCE TO RELATED APPLICATIONS

This Application claims the benefit of U.S. Provisional Application No. 62/214,295, filed Sep. 4, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to adult novelty items and in particular to a vibrating double pleasure or double penetration sex toy. During many intimate encounters, satisfaction of a female partner is often the final obstacle to satisfaction for both partners. The use of double penetration, achieving vaginal and anal stimulation simultaneously, has proven to be satisfying for many women when other methods are less than effective. Vaginal penetration with a vibrating sex toy has also proven to be satisfying. A sex toy which combines both of these functions, which is safe and comfortable to use, would be well received. A vibrating double pleasure or double penetration sex toy, which provides a large protrusion and a vibrating small protrusion, and is rounded and contoured for maximum comfort and stimulation, would resolve this problem.

### SUMMARY OF THE INVENTION

Accordingly, the invention is directed to a vibrating double pleasure or double penetration sex toy. The sex toy is curved and generally semi-rigid, providing a large protrusion and a vibrating small protrusion at each end of the main body. The small protrusion is retractable, and extends and retracts when a retraction control button on the bottom surface of the main body is pressed. The small protrusion also provides three vibration speeds, which may be controlled by pressing one of three speed control buttons on the side surface of the main body. The large protrusion and the small protrusion are generally phallic in shape, and may provide removable, flexible covers of various shapes to provide stimulation to different areas.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a front perspective view of the first exemplary embodiment, displaying the sex toy 10, the main body 11, the small protrusion 12, the large protrusion 13, the retraction control button 14, and the speed control buttons 15.

FIG. 2 is a side view of the first exemplary embodiment, displaying the sex toy 10, the main body 11, the small protrusion 12, the large protrusion 13, the retraction control button 14, and the speed control buttons 15.

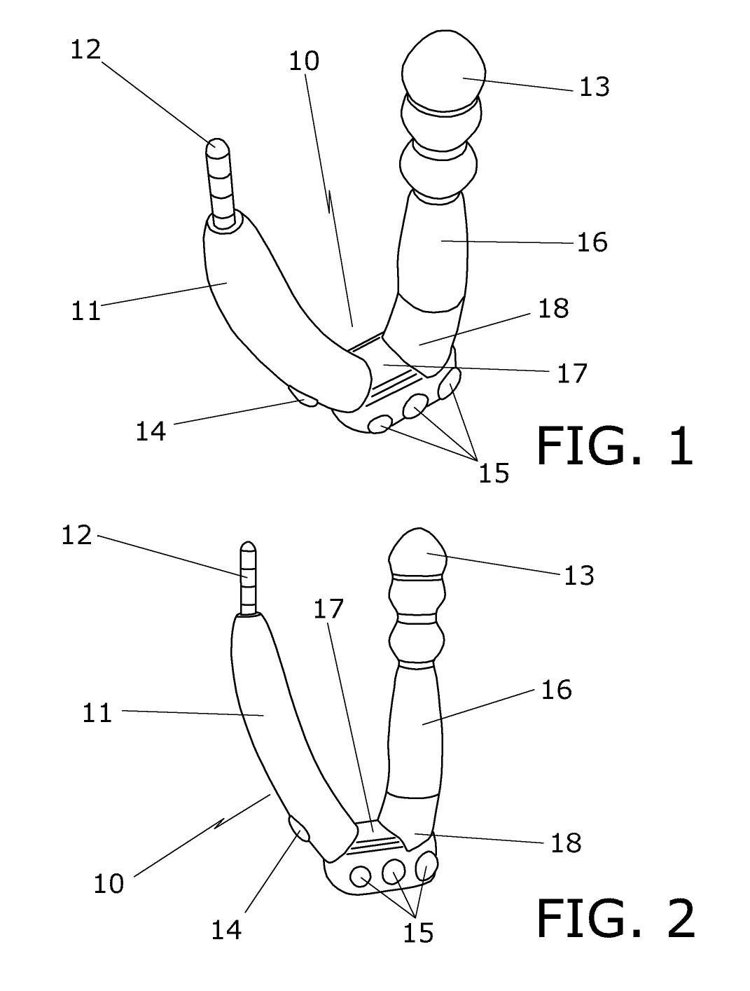

### DETAILED DESCRIPTION OF THE INVENTION

Referring now to the invention in more detail, the invention is directed to a vibrating double pleasure or double penetration sex toy 10.

The first exemplary embodiment is comprised of a sex toy 10 which is curved and generally semi-rigid, providing a large protrusion 13 at the end of a first arm 16 and a vibrating small protrusion 12 at each end of the second arm 11. The sex toy 10 is preferably powered by any means of providing power such as a plurality of cylindrical, replaceable batteries of a standard size and substantial capacity, such as two “D” cell batteries. The means of providing power being located within the main body 17.

The small protrusion 12 is retractable, and extends and retracts when a retraction control button 14 on the bottom surface of the second arm 11 is pressed. The small protrusion 12 also provides three vibration speeds, which may be controlled by pressing one of three speed control buttons 15 on the side surface of the main body 17. The retraction and vibration functions of the small protrusion 12 are preferably provided by two small servomotors.

The large protrusion 13 and the small protrusion 12 are generally phallic in shape, and may provide removable, flexible covers of various shapes to provide stimulation to different areas of the body. The entire exterior surface of the sex toy 10 is preferably rounded, and is preferably manufactured from materials which are non-absorbent and easily cleaned, such that personal lubricants may be applied. The large protrusion 13 may provide a fully flexible joint 18 with the main body, which may be comprised of a ball-and-socket joint, a coil spring, a leaf spring, a hinge, or some other mechanism.

To use the first exemplary embodiment, the user may press the retraction control button 14 to extend the small protrusion 12, and may elect to apply personal lubricant to the sex toy 10 as desired. The user then positions the sex toy 10 between the thighs, such that the small protrusion 12 is stimulating the vagina and the large protrusion 13 is stimulating the anus, and may elect to insert the small protrusion 12, the large protrusion 13, or both. The user may control the vibration speed of the small protrusion 12 by pressing one of the three speed control buttons 15 which are provided.

The main body 17, first arm 16, second arm 11, the small protrusion 12, and the large protrusion 13 are preferably manufactured from rigid, durable materials, such as plastic, aluminum alloy, steel, and wood, which are coated with flexible, durable materials which are non-absorbent and easily cleaned, such as rubber or silicone. The retraction control button 14 and the speed control buttons 15 are preferably manufactured from a flexible, durable material, such as rubber or silicone.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A sex toy, comprising:
a. a main body;
b. a first arm affixed to the main body;
c. a large protrusion at the end of the first arm;
d. a second arm affixed to the main body;
e. a small protrusion at the end of the second arm;
f. said small protrusion being retractable within the second arm such that the small protrusion retracts within and extends outside of the second arm when activated.
